(19) United States
(12) Patent Application Publication
(10) Pub. No.: US 2011/0162272 A1
(43) Pub. Date: Jul. 7, 2011

(54) Container gardening system

(76) Inventor: Gerald Junkeer, South Yarra (AU)

(21) Appl. No.: 12/932,996

(22) Filed: Mar. 11, 2011

(30) Foreign Application Priority Data
Sep. 16, 2008 (AU) 2008100918
Apr. 21, 2009 (AU) PCT/AU2009/000497

(51) Int. Cl. A01G 25/00; A01G 9/02

(52) U.S. Cl. 47/66.7; 47/81

(57) ABSTRACT

A container having upwardly and outwardly extending walls from a base to a rectangular open top that can be covered by flexible top or lid and with walled shape includes ribbing for strength and for nestable stacking in delivery. The container to form a top section above the platform and a lower section below the plate and providing an air pocket between the plant material and plant growth material in the upper section and the water in the water reservoir in the lower section by providing outlet of water at a level just below the upper section; and maintaining water reservoir with inlets and outlets with restricted communication to the external environment such that mosquito ingress is prevented while providing a self watering gardening system with water overflow.

### FIELD OF THE INVENTION

This invention relates to container gardening system and in particular to a self watering gardening system.

Whilst the invention may be applied to other container gardening systems, for convenience sake it shall be described herein in terms of a self watering gardening system.

### BACKGROUND

In the field of container gardening systems it is attempted to have a full limited environment that is suitable for a particular plant to thereby maximise its growth and its health. This is particularly the case for commercial growers supplying to the domestic market, the garden supply market or for particular commercial venues.

Further there are many forms of limited environments formed to simulate rainforest, temperant, drought, mountain or other environmental conditions.

Also in large commercial settings it is important to minimise labour intensity and therefore provide self sufficient growing environments. Further it is important to minimise water usage.

However such attempts at fulfilling these varied requirements has generally resulted in a self watering open systems that allow mosquitoes and other airborne insects to breed in the substantially still water reservoirs.

Accordingly, it is an object of the present invention to overcome or substantially ameliorate the disadvantages of the prior art by providing a mosquito free container gardening systems.

### SUMMARY OF THE INVENTION

The present invention provides a container gardening system comprising one or more containers forming a dual section gardening environment, a top section based on a platform for receiving plant matter and a growing medium such as soil; and a lower section including a chamber for receiving water and acting as water reservoir and having capillary action means for drawing water from the reservoir to self water the plant matter and a growing medium in the upper section, the lower section including water infeed to the water reservoir that is closeable and the water reservoir being substantially sealed such that mosquito ingress is prevented while providing a self watering gardening system.

The water infeed can be a transparent closeable tube extending along a side of the one or more containers and visible from the exterior and feeding directly to the water reservoir of the lower section with a cap allowing for ready external filling of the water reservoir and ready external determination of the quantity of water in the water reservoir while allowing the system to remain substantially closed at all times except when filling.

The one or more containers include a plurality of overflow outlets leading at or near the meeting of the upper and bottom sections and having a size and construction to allow water egress from excessive watering without allowing mosquito ingress.

In one form the invention provides a container gardening system including a single container with an open top and a platform having plurality of hollow legs extending from openings in the platform, the platform preferably including plurality of small holes wherein the platform creates a dual section gardening environment within the container with a top section based above the platform for receiving plant matter and a growing medium such as soil; and a lower section under the platform forming the chamber for receiving water and acting as water reservoir and the hollow legs receiving plant matter and extending into the water reservoir to form capillary action means for drawing water from the reservoir to self water the plant matter and a growing medium in the upper section, the lower section including water infeed to the water reservoir that is closeable and the lower section further including a plurality of overflow outlets formed in the container at the top of the water reservoir having a size and construction to allow water egress from excessive watering without allowing mosquito ingress whereby the water reservoir is substantially sealed such that mosquito ingress is prevented while providing a self watering gardening system

The invention also provides a method of gardening using containers including the steps of:
a. providing a container with a dual section for receiving plant material and plant growth material in the upper section and providing water reservoir in the lower section;
b. providing an air pocket between the plant material and plant growth material in the upper section and the water in the water reservoir in the lower section by providing outlet of water at a level just below the upper section; and
c. maintaining water reservoir with inlets and outlets with restricted communication to the external environment such that mosquito ingress is prevented while providing a self watering gardening system with water overflow.

In one form there is provided a container gardening system comprising an open top container means having a bottom and peripheral walls extending from said bottom to the open top to form a reservoir able to hold water. Platform means is positionable to provide a plate surface above said reservoir for supporting plant material and plant growth material. The platform means having peripheral edges for engaging said inner surfaces of the periphéral walls of said open top container means. The platform means having a plurality of feet to provide spaced location of the plate surface away from said bottom. The feet of said platform means being hollow and open to the volume above the platform to receive plant material and plant growing material therein; said feet of said platform means including fluid communication to the reservoir to provide a capillary action through plant material and plant growing material in the feet to the plant material and plant growing material above the plate of the platform; said platform means allowing the plate to be positionable above a maximum water level of the reservoir to maintain the water level in said water reservoir below the plant material and plant growing material on the plate of the platform.

Said water level can be controlled by an input means comprising a water infeed with externally visible measurable indication of water level in the water reservoir to the atmosphere outside said container means; and said water level further being controlled by an output means at a side location below the plate of the platform adjacent to allow outflow of excess water; said input means and output means to the water reservoir having restricted or closeable communication to the external environment such that mosquito ingress is prevented while providing a self watering gardening system with water overflow; a cover means for covering the open top having an opening therethrough for allowing plant growth, whereby a substantially controlled environment is maintained.

It can be seen that the container gardening system provides control of access to the water reservoir while still providing the substantial advantages of self watering and external determination of water levels in the closed water reservoir. This therefore eliminates any problems with unwanted mosquito breeding.

Plants grown in self-watering pots of the invention out-perform and out-yield those grown in traditional backyard gardens. The system utilises a unique self-watering systems that uses less water than in-ground cultivation. The plastic cover reduces the evaporation rate and returns the condensed water vapour back to the reservoir. The fully contained system can be placed anywhere with minimal fuss or mess. The result allows the plants to receive all nutrients as and when they need.

Plants absorb moisture through their roots and exhaust it through their leaves. The roots draw up water through a process of osmosis. This phenomenon is the result of, what is referred to as, transpiration pull. Plants in self-watering pots of the invention have continuous access to water so transpiration pull is never interrupted. The plants grow continuously at peak performance.

Another benefit of the self-watering pot is the ability to add fertiliser to the water itself. You can use a dilute solution added to the water, and the plant receives a tiny amount throughout the growing season.

Plants growing in pots of the invention cannot be over-watered due to the placement of the overflow holes, which is also designed to create an air cushion between the potting mix lying on a perforated inner plate and the water reservoir.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a perspective view of a container gardening system in accordance with a first embodiment of the invention;

FIG. 2 is a side view of the container of the container gardening system of FIG. 1;

FIG. 3 is a perspective view of a platform for insertion in the container to form the container gardening system of FIG. 1;

FIG. 4 is a cross section of the container gardening system through A-A of FIG. 1;

FIG. 5 is a perspective end detail of the closeable water infeed and external water level indicator of the container gardening system of FIG. 1;

FIG. 6 is a diagrammatic side view of the operation of the container of the container gardening system of FIG. 1; and

FIG. 7 is a further diagrammatic side view of the operation of the container of the container gardening system of FIG. 1.

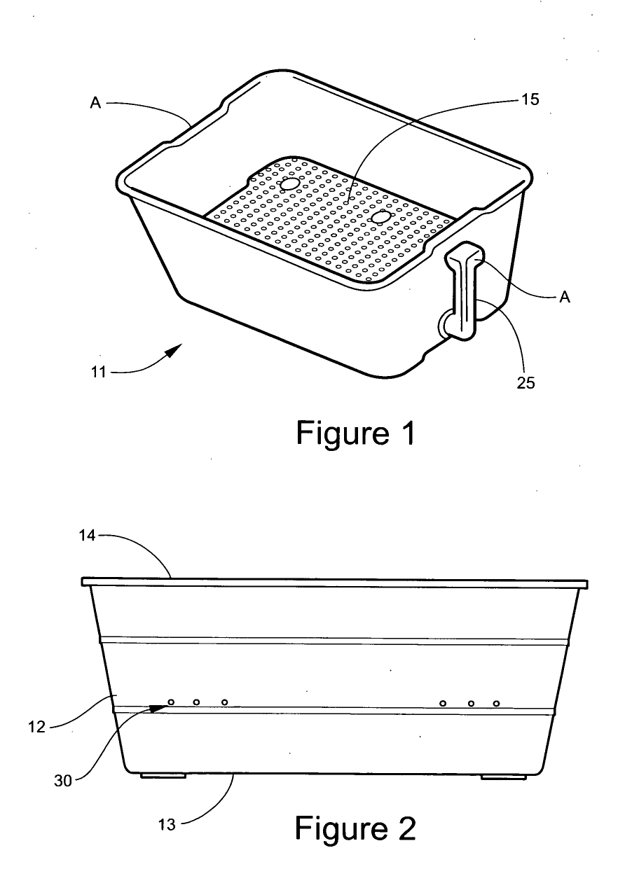

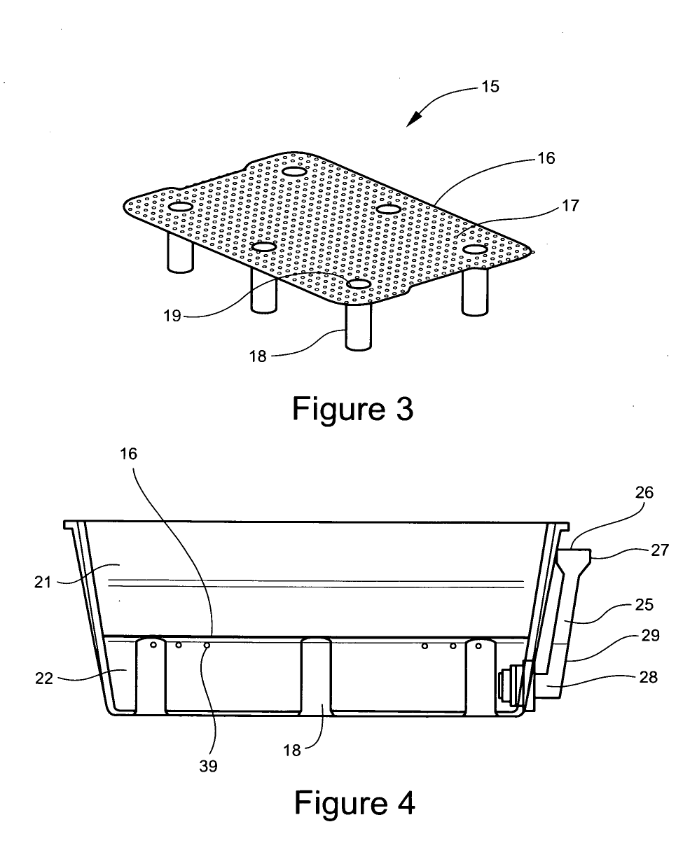

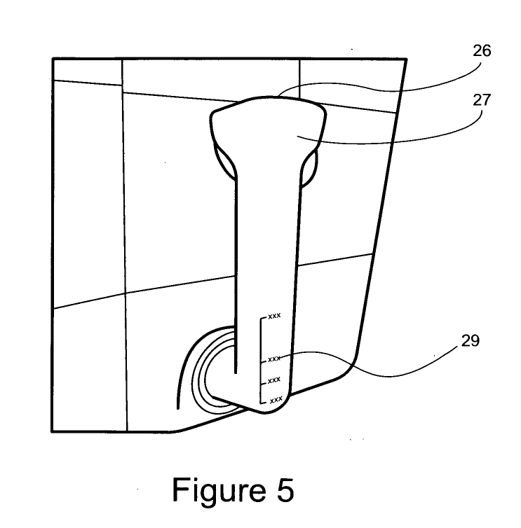

### DESCRIPTION OF PREFERRED EMBODIMENTS

In this preferred embodiment, the invention provides a container 11 having upwardly and outwardly extending walls 12 from a base 13 to a rectangular open top 14 that can be covered by flexible top or lid as required. The walled shape includes ribbing for strength and for nestable stacking in delivery.

The container is able to receive a closely fitting plate 16 of a platform 15 with complementary outer shape to the inner shape of the container and having a plurality of legs 18 extending down from the plate of the platform to rest on base 13 of the container 11 and maintain plate 16 at a spaced distance therefrom to form a top section 21 of the container above the plate 16 of the platform 15 but below the open top 14 and a lower section 22 below the plate 16 of the platform 15 and above the base 13 of the container 11.

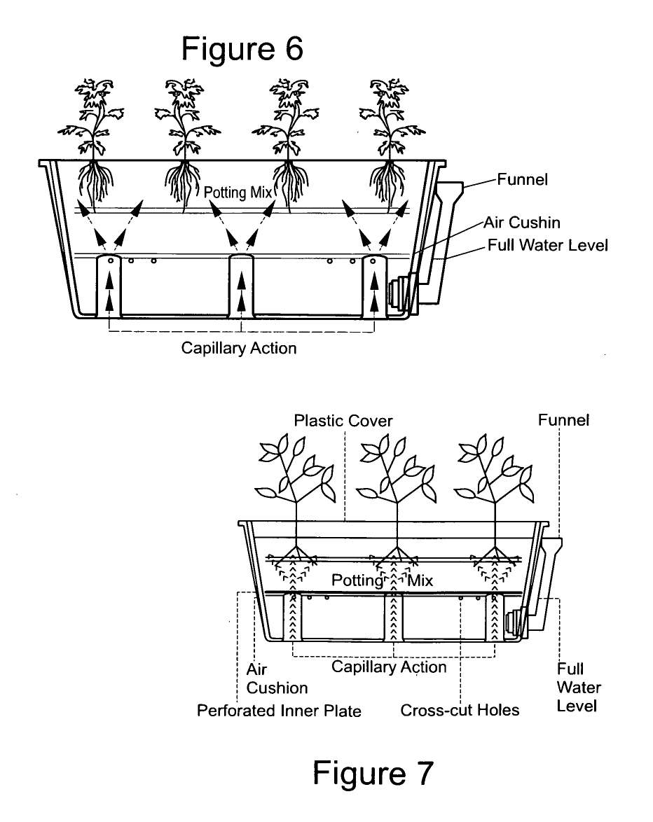

The plate 16 of the platform 15 is uniformly perforated with a plurality of small holes 17. In this form it is able to hold the growing medium in place, while the plurality of small holes provide aeration from the lower section 22. In particular as shown in FIGS. 6 and 7 the box includes multiple overflow holes 30 on the side walls of the planter box substantially below the level of the platform 15 to allow excess water to be removed when the plants are over-watered and thereby provide an air pocket 31 between the underneath of platform and the water in the water reservoir in the lower section 22.

The plurality of legs 18 (six shown) are hollow legs extending from openings 19 in the plate 16 of the platform 15 and having a cartwheel shaped bottom end (not shown). Thereby growing medium is able to be placed on the plate 16 of the platform and extend into the hollow legs but will not pass through the perforated holes 17 of the plate and will be substantially held from passing through the cartwheel bottom end of the hollow legs 18.

Thereby the platform 16 creates a dual section gardening environment within the container 11 with a top section 21 based above the platform for receiving plant matter and a growing medium such as soil and a lower section 22 under the platform 16 forming the chamber for receiving water and acting as water reservoir.

As the hollow legs 18 receive plant matter and extend from the bulk of the plant matter on the platform 15 into the water reservoir in the lower section 22 it forms a capillary action or wicking means for drawing water from the reservoir to self water the plant matter and a growing medium in the upper section.

The lower section including water infeed 25 to the water reservoir that is closeable and the lower section further including a plurality of overflow outlets formed in the wall 12 of the container 11 at the top of the water reservoir in the lower section 22 and having a size and construction to allow water egress from excessive watering without allowing mosquito ingress whereby the water reservoir is substantially sealed such that mosquito ingress is prevented while providing a self watering gardening system. The over flow holes 30 can have dimensions of the order of 5 millimetres and even then include cross barrier so they have a size and construction to allow water egress from excessive watering without allowing mosquito ingress.

The lower section includes water infeed 25 to the water reservoir that is closeable. The water infeed 25 is a transparent tube having a openable hinged lid top 26 on a top funnel section 27 for feeding water to a lower inlet 28 fitting into opening in lower portion of wall 12 of the container 11 to feed directly into the water reservoir formed by the lower section 22 of the two section container. The lower inlet 28 can be sealingly fitted by washer and nut on inner and outer side of the container 11. The transparent tube of the water infeed 25 extends along an outer side of the container 11 and includes markings 29 so that in use the water level is visible from the exterior. The placement of the transparent pipe is at the lowest point of the base, so that the level of water in the container can be read easily. An indicator line can be marked on the pipe to show the water level at 2 mm lower from the bottom edge from the 5 mm overflow holes. The transparent pipe insert can be 20 mm round the outer body below the funnel section 27 should be 30 mm by 20 mm with rounded edges. This is made in clear copolymer.

Further the feeding directly to the water reservoir of the lower section with an openable lid 26 allows for ready external filling of the water reservoir and ready external determination of the quantity of water 29 in the water reservoir while allowing the system to remain substantially closed at all times except when filling.

Preferably the whole product is manufactured in a plastic suitable for food grade so that it eliminates any harmful residues if food is being grown in the container.

The top surrounding edge of the container can be of 12 mm wide and 10 mm height with 2 mm indent on the top edge where the handle is located with a finish size of 15 mm where the reinforcement indents appears. On the wide side (not the length) the reinforcement indent to be 5 mm and four legs can be moulded to the underside of the container in arch shaped.

In a kit of the invention as shown in the drawings there is included:
1. A pot for planting.
2. A visual water level indicator.
3. A washer with indents to fit the locking system of the indicator to the container.
4. A washer to prevent leaks from inside.
5. A nut to fasten the indicator to the container.
6. Lid for the indicator.
7. A perforated inner plate for aeration with 6-8 legs.
8. A plastic cover.
9. Instructions for assembly and usage of pot.

In construction:
1. Fit the washer with the indents in position on the visual water indicator.
2. Insert the visual water indicator into the pot.
3. Fit the 2nd washer on the inside firmly against the side of the pot.
4. Fasten the nut making sure it is fitted tight to prevent leakage.
5. Ensure the visual water level indicator is fitted properly and there are no leaks by filling the visual water indicator to maximum level.

Planting Preparation
1. The invention pot should be placed where it will receive 6 to 8 hours of sunlight per day.
2. Fill water reservoir through visual water indicator to maximum level.
3. Place inner plate in the invention pot container.
4. Fill to the halfway line with potting mix (not soil). It is important that the inner plate slots are filled firmly with potting mix as these slots will act as wicks and draw water to the plant.
5. Add 2 cups of dolomite (required to balance the ph levels) and 2 cups of fertilizer (i.e. Blood & Bone for organic fertilizer or chemical fertilizer) to the remaining potting mix to fill the rest of the pot.

Planting Methods:

Method 1
1. Mix the fertilizer as listed above to the top 3-4 inches of potting mix in the container.
2. Dig a hole into the potting mix and place the plant firmly in the potting mix.
3. Water the plants from the top (when initially planting only) to remove any air pockets from around the roots.

Optional Method 2—When using the plastic cover (recommended)
1. Mix the fertilizer as listed above to the top 3-4 inches of potting mix in the pot.
2. Stretch the plastic cover over the top of the pot of the invention and secure the top edge of the box. Cut 4 mm “X” (cross cuts) in the plastic cover to plant each seedling.
3. Dig through the plastic cover into the potting mix and place the plant firmly in the potting mix.
4. Water the plants from the top (when initially planting only), through the crosscut, to remove any air pockets from around the roots.
5. The cover can be removed but, ideally, it should be left on. The cover keeps the potting mix moist by preventing evaporation, keeps the humidity level high, and stops unwanted plants getting into the pot.

It can be seen that the invention provides:
a self-watering pot, manufactured in food grade plastics providing a hassle free growing system.
Beat the increasing water restrictions by saving and harvesting water.
Easily grow your own organic vegetables and herbs in almost any space.
Combat the rising cost of living.
Free from weeding.
The water level indicator eliminates the dilemma of guess work of over watering or under watering.
The built-in tank ensures that frequent watering is not required, thereby making it possible to leave the plants unattended for extended periods of time.
Plants in self-watering pots of the invention have continuous access to water so transpiration pull is never interrupted. The plants grow continuously at peak performance.
Requires less effort and less time.
Contributes to a healthier lifestyle.
Our design prevents mosquitoes and other insects from entering the reservoir and yet creates the necessary aeration for plant roots.
The design also stops root rot by preventing over-watering, allowing aeration, and supporting drainage.

Residential

Grow fresh herbs and vegetables in your own house, flat or apartment.

In today's busy world it is hard to find time for growing and maintaining vegetable gardens. The invention removes all those barriers. The pots of the invention employ a clean, modern design that is not only functional but aesthetically pleasing and versatile enough fit in almost any space.

Commercial Farming

The invention is perfect for commercial production of vegetables, herbs and flowers. In-ground plants have continuous problems with soil erosion, increased fertiliser requirement, and loss of water through run-off. There is no dependency on land fertility—any area can be transformed into productive land. Also the invention allows you to mix your potting medium to your specifications, fertiliser never leaves the container, there is no soil erosion, and no water loss through the elimination of run-off. Produce receives constant water access allowing optimal growing conditions. All this has the capacity to dramatically increase the yield of conventional crop techniques in a much shorter period of time.

The invention gives the grower the choice of easily producing organic vegetables. The self-contained system eliminates the preparation period usually required to certify fields for organic production, as well as the need to rotate crops. As each pot is a self-contained system transition periods required for traditional cultivation are irrelevant.

Benefits to farmers include the following:
Transform unused land
Maximise return per acre
Save water
Better quality
No run-off
No soil erosion

The self-watering pots of the invention can be used to grow just about any vegetable or herb, including vegetables and fruits such as Artichokes, Asparagus, Asian Greens, Basil, Beans Green, Bok Choy, Broad Beans, Beetroot, Broccoli, Brussels Sprouts, Cabbage, Capsicum, Carrots, Cauliflower, Celery, Chinese Cabbage, Chilies, Chives, Choke, Corn, Cucumbers, Eggplants, Flowers, Fennel, Garlic, Greens, Kohlrabi, Leeks, Lettuce, Melons, Mint, Okra, Onions, Peas, Potatoes, Pumpkins, Salad Greens, Shallots, Spinach, Squash, Silver Beet, Spring Onions, Strawberries, Turnips, Tomatoes and Zucchini. It can also be used for herbs such as Basil, Coriander, Chive, Dill, Parsley (Common & Italian), Mint, Marjoram, Sage, Thyme, and Tarragon. The geographic location may impact on the type of produce that can be grown.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A self-watering planter box comprising a platform above a water reservoir with open tubular legs extending from the platform into the reservoir allowing capillary action or wicking of the water to plants on the platform and including an externally visible level indicator of water in the reservoir to allow control of water level in the water reservoir.

2. A self-watering planter box according to claim 1 wherein the externally visible water level indicator is external to the planter box.

3. A self-watering planter box according to claim 2 wherein the box includes multiple overflow holes on the side walls of the planter box substantially below the level of the platform to allow excess water to be removed when the plants are over-watered and thereby provide an air pocket between the underneath of platform and the water in the water reservoir.

4. A self-watering planter box according to claim 3 including perforations on the platform base to allow aeration of soil on the platform from the air pocket between the underneath of platform and the water in the water reservoir.

5. A self-watering planter box according to claim 4 wherein the box includes a closeable water infeed pipe that feeds to the water reservoir in the box for refilling water into the reservoir.

6. A self-watering planter box according to claim 2 wherein the box includes a closeable transparent water infeed pipe external to the box and feeding to the water reservoir in the box for refilling water and also acting as a water level indicator.

7. A self-watering planter box according to claim 6 wherein the box includes water reservoir with inlets and outlets with restricted communication to the external environment such that mosquito ingress is prevented while providing a self watering gardening system with water overflow.

8. A self-watering planter box according to claim 7 wherein the box is formed of food grade plastics such that the planter box can be used for growing edible food crops.

9. A self-watering planter box according to claim 8 wherein the box walled shape includes ribbing for strength and for nestable stacking.

10. A container gardening system comprising:
one or more containers forming a dual section gardening environment, with:
a top section on a base for receiving plant matter and a growing medium such as soil; and
a lower section including a chamber for receiving water and acting as water reservoir and having capillary action means for drawing water from the reservoir to self water the plant matter and the growing medium in the upper section,
wherein the lower section includes water infeed to the water reservoir that is closeable,
and wherein the water reservoir is substantially sealed such that mosquito ingress is prevented while providing a self watering gardening system.

11. A container gardening system according to claim 10 wherein the water infeed is a transparent closeable tube extending along a side of the one or more containers and visible from the exterior and feeding directly to the water reservoir of the lower section with a cap allowing for ready external filling of the water reservoir and ready external determination of the quantity of water in the water reservoir while allowing the system to remain substantially closed at all times except when filling.

12. A container gardening system according to claim 10 wherein the one or more containers include a plurality of overflow outlets externally from near the meeting of the upper and bottom sections and having a size and construction to allow water egress from excessive watering without allowing mosquito ingress.

13. A container gardening system according to claim 10, wherein the container gardening system comprises:
a single container with an open top and a platform having plurality of hollow legs extending from openings in the platform, the platform preferably including plurality of small holes
wherein the platform creates a dual section gardening environment within the container with a top section based above the platform for receiving plant matter and a growing medium such as soil;
and a lower section under the platform forming the chamber for receiving water and acting as water reservoir and the hollow legs receiving plant matter and extending into the water reservoir to form capillary action means for drawing water from the reservoir to self water the plant matter and a growing medium in the upper section,
the lower section including water infeed to the water reservoir that is closeable and the lower section further including a plurality of overflow outlets formed in the container at the top of the water reservoir having a size and construction to allow water egress from excessive watering without allowing mosquito ingress whereby the water reservoir is substantially sealed such that mosquito ingress is prevented while providing a self watering gardening system

14. A container gardening system comprising:
a. an open top container means having a bottom and peripheral walls extending from said bottom to the open top to form a reservoir able to hold water;
b. platform means positionable to provide a plate surface above said reservoir for supporting plant material and plant growth material;
i. said platform means having peripheral edges for engaging said inner surfaces of the peripheral walls of said open top container means;
ii. said platform means having a plurality of feet to provide spaced location of the plate surface away from said bottom;
iii. said feet of said platform means being hollow and open to the volume above the platform to receive plant material and plant growing material therein
iv. said feet of said platform means including fluid communication to the reservoir to provide a capillary action through plant material and plant growing material in the feet to the plant material and plant growing material above the plate of the platform;
v. said platform means allowing the plate to be positionable above a maximum water level of the reservoir to maintain the water level in said water reservoir below the plant material and plant growing material on the plate of the platform,
1. said water level being controlled by an input means comprising a water infeed with externally visible measurable indication of water level in the water reservoir to the atmosphere outside said container means; and
2. said water level further being controlled by an output means at a side location below the plate of the platform adjacent to allow outflow of excess water;
3. said input means and output means to the water reservoir having restricted or closeable communication to the external environment such that mosquito ingress is prevented while providing a self watering gardening system with water overflow;
c. a cover means for covering the open top having an opening therethrough for allowing plant growth, whereby a substantially controlled environment is maintained.

15. A container gardening system according to claim 14 wherein said cover means is an attachable lid.

16. A container gardening system according to claim 14 wherein said cover means is a flexible elastic edged cover for engaging the upper walls of the open top container.

17. A method of gardening using containers comprising the steps of:
a. providing a container with a dual section for receiving plant material and plant growth material in the upper section and providing water reservoir in the lower section;
b. providing an air pocket between the plant material and plant growth material in the upper section and the water in the water reservoir in the lower section by providing outlet of water at a level just below the upper section; and
c. maintaining water reservoir with inlets and outlets with restricted communication to the external environment such that mosquito ingress is prevented while providing a self watering gardening system with water overflow.

18. A self-watering planter box according to claim 1 further comprising a platform above a water reservoir with open tubular legs extending from the platform into the reservoir allowing capillary action or wicking of the water to plants on the platform and including:
a. an externally visible level indicator of water in the reservoir located external to the planter box to allow control of water level in the water reservoir;
b. multiple overflow holes on the side walls of the planter box substantially below the level of the platform to allow excess water to be removed when the plants are over-watered and thereby provide an air pocket between the underneath of platform and the water in the water reservoir;
c. perforations on the platform base to allow aeration of soil on the platform from the air pocket between the underneath of platform and the water in the water reservoir; and
d. a water infeed pipe that feeds to the water reservoir in the box for refilling water into the reservoir;
wherein the box includes the water reservoir having inlets and outlets with restricted communication to the external environment, said inlets and outlets including:
e. the water infeed pipe being closeable; and
f. the plurality of overflow outlets formed in the container at the top of the water reservoir having a size and construction preventing mosquito ingress but allowing water egress from excessive watering;
whereby mosquito ingress is prevented to the reservoir while providing a self watering gardening system with water overflow.
